(19) United States
(12) Patent Application Publication
(10) Pub. No.: US 2013/0241293 A1
(43) Pub. Date: Sep. 19, 2013

(54) POWER CONTROL SYSTEM AND ELECTRONIC APPARATUS

(71) Applicant: Kohhei YAMAGUCHI, Kanagawa (JP)

(72) Inventor: Kohhei YAMAGUCHI, Kanagawa (JP)

(21) Appl. No.: 13/782,534

(22) Filed: Mar. 1, 2013

(30) Foreign Application Priority Data
Mar. 14, 2012 (JP) 2012-057870

(51) Int. Cl. H02J 4/00

(52) U.S. Cl. CPC H02J 4/00
USPC 307/66

(57) ABSTRACT

A power control system includes an electronic apparatus; and a power transmission apparatus configured to send power to the electronic apparatus. The power transmission apparatus includes a power generation unit configured to generate the power; a first communication unit configured to communicate with the electronic apparatus; and a power transmission unit configured to send the generated power to the electronic apparatus in response to a request from the electronic apparatus. The electronic apparatus includes a second communication unit configured to send, to the power transmission apparatus, a request for starting or stopping supplying the power; a power receiving unit configured to receive the power from the power transmission apparatus; and a control unit configured to reduce the power supplied to the second communication unit in a power saving mode.

### CROSS-REFERENCE TO RELATED APPLICATION

The present application claims priority to and incorporates by reference the entire contents of Japanese Patent Application No. 2012-057870 filed in Japan on Mar. 14, 2012.

### BACKGROUND OF THE INVENTION

1. Field of the Invention

The present invention relates to a power control system and an electronic apparatus.

2. Description of the Related Art

In electronic apparatuses such as image forming apparatuses, reduction of power consumption is an essential issue for reducing global environmental problems and running cost for users. For example, Japanese Patent Application Laid-open No. 2005-237095 discloses a technique in which, for the purpose of energy saving, a main power supply that supplies power to various parts of an equipment main unit, a photovoltaic cell, and a secondary battery are provided, and during a power saving mode, the main power supply stops operating while the various parts of the equipment main unit are supplied with power from the secondary battery.

However, in the technique disclosed by Japanese Patent Application Laid-open No. 2005-237095, the photovoltaic cell is built into an image forming apparatus. Therefore, there is a problem that a sufficient amount of power is not obtained when the image forming apparatus is not irradiated by a sufficient amount of sunlight. In other words, the technique disclosed by Japanese Patent Application Laid-open No. 2005-237095 cannot sufficiently reduce the power consumption.

Therefore, there is a need to provide a power control system and an electronic apparatus that can achieve further reduction in power consumption.

### SUMMARY OF THE INVENTION

It is an object of the present invention to at least partially solve the problems in the conventional technology.

According to an embodiment, there is provided a power control system that includes an electronic apparatus; and a power transmission apparatus configured to send power to the electronic apparatus. The power transmission apparatus includes a power generation unit configured to generate the power; a first communication unit configured to communicate with the electronic apparatus; and a power transmission unit configured to send the power generated by the power generation unit to the electronic apparatus in response to a request from the electronic apparatus received at the first communication unit. The electronic apparatus includes a processing unit configured to perform a process; a second communication unit configured to send, to the power transmission apparatus, a request for starting or stopping supplying the power; a power receiving unit configured to receive the power from the power transmission apparatus; and a power supply control unit configured to control, in a power saving mode in which power consumption is smaller than that in a normal mode in which the power is supplied to the processing unit and the second communication unit, the power supplied to the second communication unit to a value smaller than the power supplied to the second communication unit in the normal mode.

According to another embodiment, there is provided an electronic apparatus that includes a processing unit configured to perform a process; a communication unit configured to send, to a power transmission apparatus configured to send generated power to an external device, a request for starting or stopping supplying the power; a power receiving unit configured to receive the power from the power transmission apparatus; and a power supply control unit configured to control, in a power saving mode in which power consumption is smaller than that in a normal mode in which the power is supplied to the processing unit and the communication unit, the power supplied to the communication unit to a value smaller than the power supplied to the communication unit in the normal mode.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a hardware configuration example of an image forming system according to a first embodiment of the present invention;

FIG. 2 is a flow chart illustrating an example of charge control of a power storage unit in an image forming apparatus;

FIGS. 3A and 3B are flow charts illustrating an operation example of the image forming apparatus when entering a power saving mode and when returning from the power saving mode;

FIG. 4 is a flow chart illustrating an operation example of a power transmission apparatus;

FIG. 5 is a block diagram illustrating a hardware configuration example of an image forming system according to a second embodiment of the present invention;

FIG. 6 is a flow chart illustrating an example of charge control of a power storage unit in the power transmission apparatus; and

FIGS. 7A and 7B are flow charts illustrating a modification of the operation example of the image forming apparatus.

### DETAILED DESCRIPTION OF THE PREFERRED EMBODIMENTS

Embodiments of a power control system and an electronic apparatus according to the present invention will be described below in detail with reference to the accompanying drawings. The embodiments below will be described by giving, as the electronic apparatus, an example of an image forming apparatus that has a function of forming an image on a medium. However, not limited to this apparatus, the electronic apparatus may be of any type. For example, a digital camera or a mobile phone can be employed as the electronic apparatus.

### First Embodiment

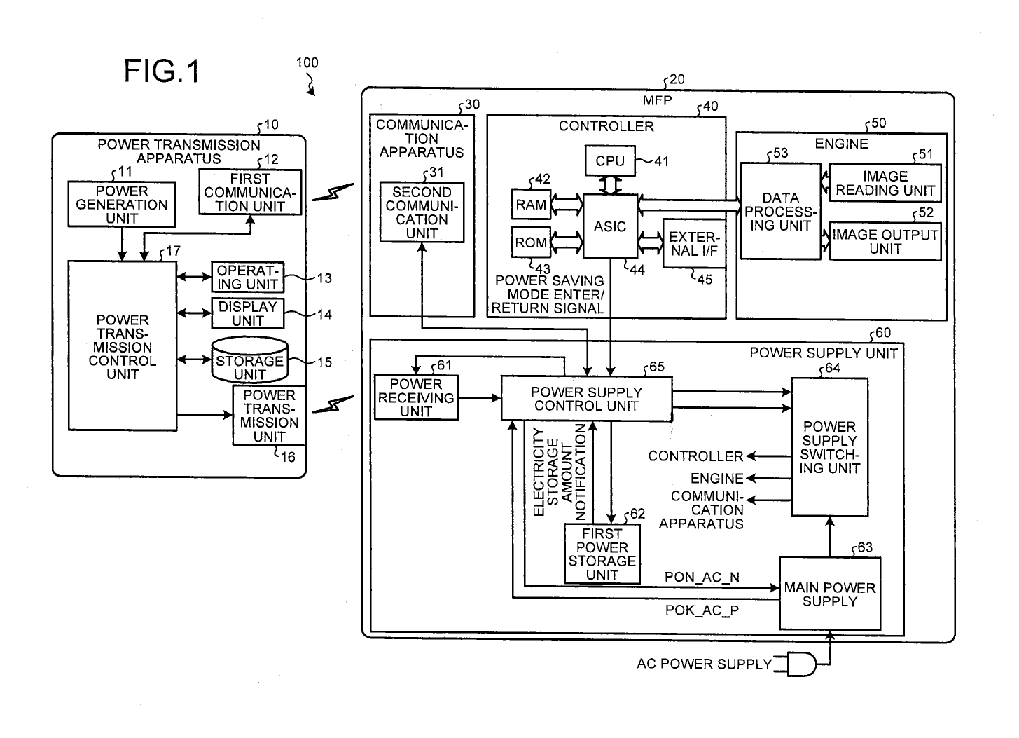

FIG. 1 is a block diagram illustrating a hardware configuration example of an image forming system (power control system) 100 according to a first embodiment of the present invention. As illustrated in FIG. 1, the image forming system 100 is provided with a power transmission apparatus 10 and the image forming apparatus (MFP) 20.

The power transmission apparatus 10 is an apparatus that can supply (can transmit) generated power to the image forming apparatus 20. Specific details of the power transmission apparatus 10 will be described below. As illustrated in FIG. 1, the power transmission apparatus 10 is provided with a power generation unit 11, a first communication unit 12, an operating unit 13, a display unit 14, a storage unit 15, a power transmission unit 16, and a power transmission control unit 17.

The power generation unit 11 is an apparatus that generates electric power. Although, in the present embodiment, the power generation unit 11 includes a photovoltaic cell, the power generation unit 11 is not limited to this configuration. The power generation unit 11 supplies the generated power to the power transmission control unit 17.

The first communication unit 12 communicates with the image forming apparatus 20. In the present embodiment, the first communication unit 12 receives, from the image forming apparatus 20, information such as a power supply start request that requests a start of power supply and a power supply stop request that requests a stop of the power supply. The first communication unit 12 notifies the power transmission control unit 17 of various type of information received from the image forming apparatus 20. Also, in response to a request received from the power transmission control unit 17, the first communication unit 12 sends, to the image forming apparatus 20, information such as supply availability information that indicates availability of supply of power and power supply stop information that indicates that the power supply is to be stopped.

For example, the first communication unit 12 can perform wireless communication with external devices such as the image forming apparatus 20 using light, electromagnetic waves, or acoustic waves. However, the communication methods are not limited to these methods. For example, a power transmission coil used for sending (transmitting) power with a magnetic field resonance technique may be used as a helical antenna to perform the communication, like a technique disclosed in Japanese Patent Application Laid-open No. 2010-141966. In other words, the power transmission unit 16 to be described later may be used to serve as the first communication unit 12.

The operating unit 13 is a device for a user to perform various input operations to the power transmission apparatus 10. The operating unit 13 may include, for example, of a keyboard, a mouse, buttons, directional keys, a jog dial, a touch panel, or a combination of these devices. However, the components are not limited to the above-listed ones.

The display unit 14 is device for displaying various types of information on the power transmission apparatus 10. The display unit 14 displays screens such as an operation screen for making the power transmission apparatus 10 perform desired operations and a screen that indicates a status of communication with the image forming apparatus 20, a status of power transmission, and the like. However, the screens are not limited to the above-listed ones. The display unit 14 can be composed, for example, of an LCD or an organic EL display. However, the display is not limited to the above-listed ones.

The storage unit 15 stores therein, for example, identification (ID) information of the image forming apparatus 20 to be supplied with power, the power supply start request, the power supply stop request, and various applications. The storage unit 15 can be composed, for example, of a magnetic recording medium such as a hard disk, or of a nonvolatile memory such as a flash memory. However, the component is not limited to the above-listed ones.

The power transmission unit 16 supplies (transmits) the power generated in the power generation unit 11 to the image forming apparatus 20. Although the power can be supplied to the image forming apparatus 20 in any manner, the power transmission unit 16 of the present embodiment uses the magnetic field resonance technique under the control of the power transmission control unit 17 to send the power generated in the power generation unit 11 to the image forming apparatus 20. Due to a principle called a magnetic field resonance phenomenon, the magnetic field resonance technique has an advantage over an electromagnetic induction technique in that the power can be transmitted to a more distant place and a drop in a transmission efficiency can be suppressed even when there is a certain degree of misalignment in position between the power transmission coil and a power receiving coil.

The power transmission control unit 17 controls the power transmission apparatus 10 in an integrated manner. The power transmission control unit 17 can be composed, for example, of an MPU. In the present embodiment, the power transmission control unit 17 has a maximum power point tracker (MPPT) function to track a point at which the power output from the power generation unit 11 is maximized. The power transmission control unit 17 calculates the amount of power generated in the power generation unit 11, and, when supplying power to the image forming apparatus 20, performs control to supply the power from the power generation unit 11 to the power transmission unit 16, and to send the power to the image forming apparatus 20 using the magnetic field resonance technique. When stopping the power supply to the image forming apparatus 20, the power transmission control unit 17 stops the power supply from the power generation unit 11 to the power transmission unit 16.

Also, the power transmission control unit 17 makes a request for the first communication unit 12 to send the various types of information (such as the supply availability information and the power supply stop information) to the image forming apparatus 20. Moreover, the power transmission control unit 17 performs control according to the information (such as the power supply start request and the power supply stop request) received at the first communication unit 12. The details thereof will be described later.

Furthermore, the power transmission control unit 17 performs control to store, in the storage unit 15, the information received at the first communication unit 12 and information entered from the operating unit 13, and to display these pieces of information on the display unit 14.

Next, specific details of the image forming apparatus 20 will be described. As illustrated in FIG. 1, the image forming apparatus 20 is provided with a communication apparatus 30, a controller 40, an engine 50, and a power supply unit 60.

The communication apparatus 30 is an apparatus that communicates with the power transmission apparatus 10, and is provided separately from an external I/F that can receive image data (such as image data described in a page-description language) from a host device such as a PC.

The communication apparatus 30 has a second communication unit 31 that wirelessly communicates with the first communication unit 12 of the power transmission apparatus 10. The second communication unit 31 receives the information such as the supply availability information and the power supply stop information from the power transmission apparatus 10. The second communication unit 31 notifies a power supply control unit 65 in the power supply unit 60 of the various types of information received from the power transmission apparatus 10. Also, in response to a request received from the power supply control unit 65, the second communication unit 31 sends the information such as the power supply start request and the power supply stop request to the power transmission apparatus 10.

For example, the second communication unit 31 can perform wireless communication with the power transmission apparatus 10 using light, electromagnetic waves, or acoustic waves. However, the communication methods are not limited to these methods. For example, the power transmission coil used for sending (transmitting) power with the magnetic field resonance technique may be used as the helical antenna to perform the communication, like the technique disclosed in Japanese Patent Application Laid-open No. 2010-141966. In other words, a power receiving unit 61 to be described later may be used to serve as the second communication unit 31.

The controller 40 is an apparatus that controls the image forming apparatus 20 in an integrated manner. The controller 40 is provided with a CPU 41, a RAM 42, a ROM 43, an ASIC 44, and an external I/F 45. The CPU 41 loads programs stored in the ROM 43 or the like into the RAM 42 and executes the loaded programs so as to control operations of the controller 40. The ROM 43 is a nonvolatile semiconductor memory, and stores therein the control programs and various types of data. The RAM 42 is a volatile semiconductor memory that functions as work areas when the various programs stored in the ROM 43 are executed. The external I/F 45 is an interface device to which external devices such as a PC can be connected.

The ASIC 44 performs, for example, various types of image processing such as compression and decompression, input and output (I/O) processing, control of a power supply in the controller 40, and various notifications (such as a power saving mode enter notification and a power saving mode return notification) to the power supply unit 60 (power supply control unit 65). In the present embodiment, the ASIC 44 continues to be supplied with power even in the power saving mode because of a necessity to issue the power saving mode return notification to the power supply unit 60 even after the system enters the power saving mode. In the present embodiment, a state in which all elements of the communication apparatus 30 (second communication unit 31), the controller 40, and the engine 50 are supplied with power so that the image forming apparatus 20 can operate is called a “normal mode”. A state in which power is stopped being supplied to the communication apparatus 30 and the engine 50 and is supplied to only the ASIC 44 in the controller 40 is called the “power saving mode”. However, not limited to this state, the power saving mode can take any form. For example, it can be configured that the communication apparatus 30 is supplied with power even in the power saving mode, but the value of the power is set to a smaller value than the value of the power supplied to the communication apparatus 30 in the normal mode.

When the ASIC 44 has detected a power saving mode entering factor that represents a factor for entering the power saving mode, and when a state is established in which the controller 40 can enter the power saving mode (a state in which power can be stopped being supplied to the elements to be stopped being supplied with the power in the power saving mode), the ASIC 44 notifies the power supply unit 60 (power supply control unit 65) to enter the power saving mode (power saving mode enter notification). In the present embodiment, the ASIC 44 sets a power saving mode enter/return signal to be communicated to the power supply unit 60 to a high level so as to notify the power supply unit 60 to enter the power saving mode. However, the method for entering the power saving mode is not limited to this method. Any factor can be the power saving mode entering factor. For example, the factor may be an event in which an operation input of pressing a power button is given in the normal mode or an event in which a timer detects that the time to enter the power saving mode is reached.

When the ASIC 44 has detected a returning factor that represents a factor for returning from the power saving mode to the normal mode, the ASIC 44 notifies the power supply unit 60 (power supply control unit 65) to return from the power saving mode (power saving mode return notification). In the present embodiment, the ASIC 44, the ASIC 44 sets a power saving mode enter/return signal to be communicated to the power supply unit 60 to a low level so as to notify the power supply unit 60 to return from the power saving mode. However, the method for returning from the power saving mode is not limited to this method. Any factor can be the returning factor. For example, the factor may be an event in which an operation input of pressing the power button is given in the power saving mode or an event in which the timer detects that the time to return to the normal mode is reached.

The engine 50 is an apparatus that forms an image on a recording medium such as transfer paper. The engine 50 can also be understood as an “image forming unit”. As illustrated in FIG. 1, the engine 50 is provided with an image reading unit 51, an image output unit 52, and a data processing unit 53. The image reading unit 51 scans a document and obtains electronic image data. The image output unit 52 prints out image data on the recording medium such as paper. The data processing unit 53 applies a plurality of processes (such as modification, correction, edit, detection, conversion) to image data. The image data entered into the data processing unit 53 is not limited to the image data obtained in the image reading unit 51, but may be, for example, the image data (such as the image data described in the page-description language (PDL)) sent from the host device such as the PC.

The power supply unit 60 is an apparatus that can supply power to various units of the image forming apparatus 20. As illustrated in FIG. 1, the power supply unit 60 is provided with the power receiving unit 61, a first power storage unit 62, a main power supply 63, a power supply switching unit 64, and the power supply control unit 65.

The power receiving unit 61 receives the power sent from the power transmission apparatus 10. In the present embodiment, the power receiving unit 61 uses the magnetic field resonance technique to receive the power sent from the power transmission apparatus 10. Under the control of the power supply control unit 65, the power receiving unit 61 can supply the power received from the power transmission apparatus 10 to the power supply control unit 65, or can alternatively stop supplying the received power to the power supply control unit 65.

Under the control of the power supply control unit 65, the first power storage unit 62 stores (accumulates) therein the power received at the power receiving unit 61. The first power storage unit 62 can also discharge the stored power under the control of the power supply control unit 65. Further, the first power storage unit 62 can notify the power supply control unit 65 of an electricity storage amount of itself. The first power storage unit 62 can be composed, for example, of a secondary battery such as a lithium secondary battery or a nickel-metal hydride battery, or of a capacitor. However, the component is not limited to the above-listed ones.

Under the control of the power supply control unit 65, the main power supply 63 converts power (AC power) from a commercial power source into power (DC power) usable in the communication apparatus 30, the controller 40, the engine 50, and the like, and outputs the converted power (DC power) to the power supply switching unit 64. In the present embodiment, the main power supply 63 operates according to a control signal PON_AC_N from the power supply control unit 65.

The main power supply 63 is described more specifically as follows. The main power supply 63 has an input unit (not illustrated) for receiving the AC power. If the control signal PON_AC_N supplied from the power supply control unit 65 is at a low level (L), the main power supply 63 starts receiving the AC power and performs processing of converting the AC power into the DC power. Then, if the supply of the DC power to the power supply switching unit 64 is stabilized, the main power supply 63 notifies the power supply control unit 65 of a state signal POK_AC_P that is set to a low level. If, instead, the supply of the DC power to the power supply switching unit 64 is unstable, the main power supply 63 notifies the power supply control unit 65 of the state signal POK_AC_P that is set to a high level.

If the control signal PON_AC_N supplied from the power supply control unit 65 is at a high level (H), the main power supply 63 stops receiving the AC power and stops performing the processing of converting the AC power into the DC power. In this case, the main power supply 63 notifies the power supply control unit 65 of the state signal POK_AC_P that is set to a high level. Note that, even in this state (state where the DC power is not generated), the main power supply 63 is supplied with the power from the first power storage unit 62 in order to operate a circuit for performing the processing of converting the AC power into the DC power.

The main power supply 63 may be configured, for example, to have, in the input unit thereof, a relay, which in turn performs the on/off control based on the control signal PON_AC_N from the power supply control unit 65.

Under the control of the power supply control unit 65, the power supply switching unit 64 switches the source of power supplied to the units of the image forming apparatus 20 to either the power from the main power supply 63 (which can also be understood as the “power from the commercial power source”) or the power received at the power receiving unit 61 (including the power stored in the first power storage unit 62). If the source of supply of power is switched to the power from the main power supply 63, the units of the image forming apparatus 20 can be supplied with the power from the main power supply 63 and cannot be supplied with the power received at the power receiving unit 61. If, instead, the source of supply of power is switched to the power received at the power receiving unit 61, the units of the image forming apparatus 20 can be supplied with the power received at the power receiving unit 61 and cannot be supplied with the power from the main power supply 63.

Note that, not limited to this, even in the state in which the source of supply of power is switched to the power from the main power supply 63, the power received at the power receiving unit 61, if being received, can be supplied to the units of the image forming apparatus 20. For example, even when the units of the image forming apparatus 20 are supplied with the power from the main power supply 63, if the power receiving unit 61 is receiving the power from the power transmission apparatus 10, the received power can be used to supply power to the units of the image forming apparatus 20 so as to reduce the amount of power supply from the main power supply 63 (that is, the amount of power supply from the commercial power source). In the same manner, even in the state in which the source of supply of power is switched to the power received at the power receiving unit 61, the units of the image forming apparatus 20 can also be supplied with the power from the main power supply 63. For example, while the units of the image forming apparatus 20 are supplied with the power received at the power receiving unit 61, if the power supply capacity of the power transmission apparatus 10 drops, resulting in a lack of power supply, the power from the main power supply 63 can also be used to continue the power supply to the units of the image forming apparatus 20.

Under the control of the power supply control unit 65, the power supply switching unit 64 can also supply and stop the power individually to each of the units (such as the communication apparatus 30, the controller 40, and the engine 50) of the image forming apparatus 20. The value of the power supplied to each of the units (such as the communication apparatus 30, the controller 40, and the engine 50) of the image forming apparatus 20 is controlled by the power supply control unit 65. Note that, in the present embodiment, the first power storage unit 62 or the main power supply 63 supplies the power for operating the power supply switching unit 64.

The power supply control unit 65 controls the power supply unit 60 in an integrated manner. The power supply control unit 65 can be composed, for example, of an MPU. In the present embodiment, in the case of entering the power saving mode, the power supply control unit 65 performs control to stop supplying power to the second communication unit 31 (communication apparatus 30) and to switch the source of supply of power to the power received at the power receiving unit 61. More specifically, when having received the high-level power saving mode enter/return signal from the ASIC 44, the power supply control unit 65 controls the power supply switching unit 64 so as to stop supplying power to the second communication unit 31. The power supply control unit 65 also controls the power supply switching unit 64 so as to switch the source of supply of power to the power received at the power receiving unit 61, and so as to stop supplying power to the engine 50 and to the elements other than the ASIC 44 in the controller 40.

In the case of returning from the power saving mode to the normal mode, the power supply control unit 65 controls the power supply switching unit 64 so as to switch the source of supply of power to the power from the main power supply 63, and so as to resume supplying the power to the engine 50 and to the elements other than the ASIC 44 in the controller 40. Here, the power supply control unit 65 performs the above-described control when having received the low-level power saving mode enter/return signal from the ASIC 44.

The power supply control unit 65 also performs charge/discharge control of the first power storage unit 62 based on the electricity storage amount notification from the first power storage unit 62. The power supply control unit 65 further performs control to switch the power to be supplied to the power supply switching unit 64 to either the power supplied from the power receiving unit 61 or the power stored in the first power storage unit 62. In addition, the power supply control unit 65 can control the power receiving unit 61 so as to supply the power received from the power transmission apparatus 10 to the power supply control unit 65, and can control the power receiving unit 61 so as to stop supplying the received power to the power supply control unit 65. The power supply control unit 65 also controls the generation of the DC power performed by the main power supply 63 by controlling the above-described control signal PON_AC_N. Furthermore, the power supply control unit 65 requests the second communication unit 31 to send the information such as the power supply start request and the power supply stop request to the power transmission apparatus 10. The power supply control unit 65 also performs control according to the various types of information (such as the supply availability information and the power supply stop information) received at the second communication unit 31. The details thereof will be described later.

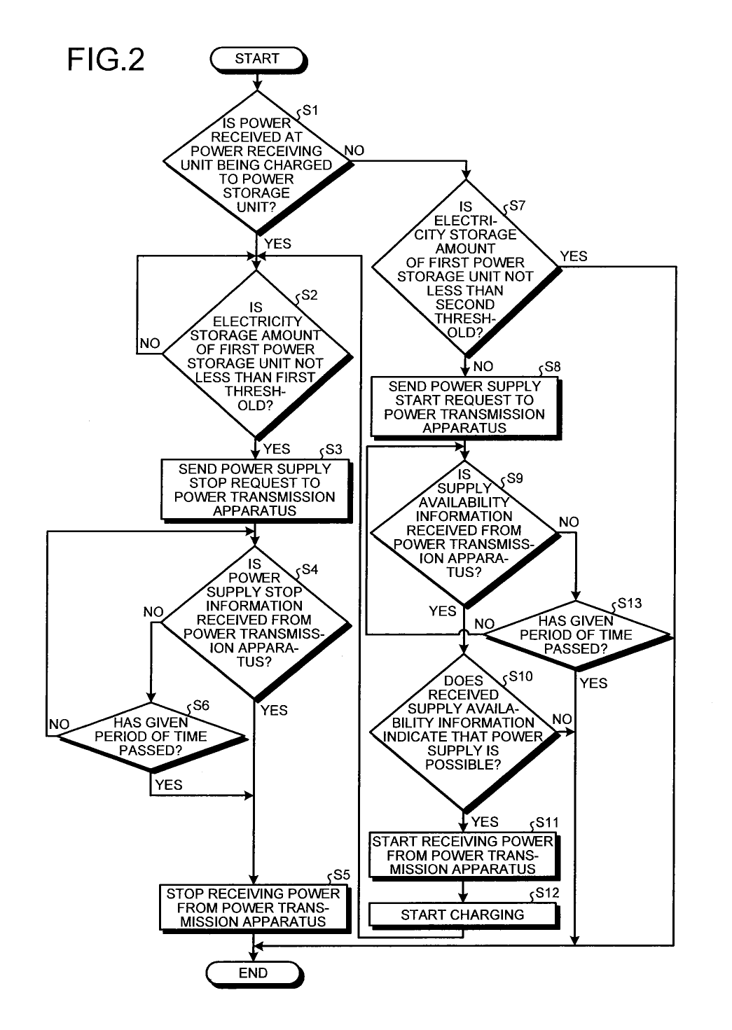

FIG. 2 is a flow chart illustrating an example of the charge control of the first power storage unit 62. Specific details of FIG. 2 will be described below. As illustrated in FIG. 2, the power supply control unit 65 first determines whether the power received at the power receiving unit 61 is currently being charged to the first power storage unit 62 (Step S1).

If determining that the power received at the power receiving unit 61 is currently being charged to the first power storage unit 62 (Yes at Step S1), the power supply control unit 65 determines, based on the electricity storage amount notification from the first power storage unit 62, whether the electricity storage amount of the first power storage unit 62 is not less than a first threshold (Step S2).

If determining that the electricity storage amount of the first power storage unit 62 is not less than the first threshold (Yes at Step S2), the power supply control unit 65 requests the second communication unit 31 to send the power supply stop request to the power transmission apparatus 10. Upon receiving the request from the power supply control unit 65, the second communication unit 31 sends the power supply stop request to the power transmission apparatus 10 (Step S3). In the present embodiment, the second communication unit 31 sends, in addition to the power supply stop request, the identification (ID) information of the image forming apparatus 20 to the power transmission apparatus 10.

Next, the power supply control unit 65 determines whether the second communication unit 31 has received the power supply stop information from the power transmission apparatus 10 (Step S4). In the present embodiment, the power supply control unit 65 determines whether it has been notified of the power supply stop information from the second communication unit 31 to determine whether the second communication unit 31 has received the power supply stop information from the power transmission apparatus 10.

If determining that the second communication unit 31 has received the power supply stop information from the power transmission apparatus 10 (Yes at Step S4), the power supply control unit 65 performs control to stop receiving the power from the power transmission apparatus 10 (Step S5). For example, the power supply control unit 65 can also control the power receiving unit 61 so as to stop supplying the power received from the power transmission apparatus 10 to the power supply control unit 65. If, instead, the second communication unit 31 has not received the power supply stop information from the power transmission apparatus 10 (No at Step S4), and if a given period of time has passed since the power supply stop request was sent (Yes at Step S6), the power supply control unit 65 also performs the control to stop receiving the power from the power transmission apparatus 10 (Step S5).

If determining at Step S1 described above that the power received at the power receiving unit 61 is not currently being charged to the first power storage unit 62 (No at Step S1), the power supply control unit 65 determines, based on the electricity storage amount notification from the first power storage unit 62, whether the electricity storage amount of the first power storage unit 62 is not less than a second threshold (Step S7). If the electricity storage amount of the first power storage unit 62 is determined to be not less than the second threshold (Yes at Step S7), the process is terminated.

If, instead, the electricity storage amount of the first power storage unit 62 is determined to be less than the second threshold (No at Step S7), the power supply control unit 65 requests the second communication unit 31 to send the power supply start request to the power transmission apparatus 10. Upon receiving the request from the power supply control unit 65, the second communication unit 31 sends the power supply start request to the power transmission apparatus 10 (Step S8). In the present embodiment, the second communication unit 31 sends, in addition to the power supply start request, the identification (ID) information of the image forming apparatus 20 to the power transmission apparatus 10.

Next, the power supply control unit 65 determines whether the second communication unit 31 has received the supply availability information from the power transmission apparatus 10 (Step S9). In the present embodiment, the power supply control unit 65 determines whether it has been notified of the supply availability information from the second communication unit 31 to determine whether the second communication unit 31 has received the supply availability information from the power transmission apparatus 10.

If determining that the second communication unit 31 has received the supply availability information from the power transmission apparatus 10 (Yes at Step S9), the power supply control unit 65 determines whether the received supply availability information indicates that the power supply is possible (Step S10). If determining that the received supply availability information indicates that the power supply is possible (Yes at Step S10), the power supply control unit 65 performs control to start receiving the power from the power transmission apparatus 10 (Step S11). In the present embodiment, the power supply control unit 65 controls the power receiving unit 61 so as to supply the power received from the power transmission apparatus 10 to the power supply control unit 65. Then, the power supply control unit 65 performs control to charge the first power storage unit 62 with the power supplied from the power receiving unit 61 (Step S12). The process after Step S12 is the same as the process of Step S2 and later described above. If, instead, it is determined that the received supply availability information indicates that power cannot be supplied (No at Step S10), the process is terminated.

Further, if the second communication unit 31 has not received the supply availability information from the power transmission apparatus 10 (No at Step S9), and if a given period of time has passed since the power supply start request was sent (Yes at Step S13), the process is also terminated.

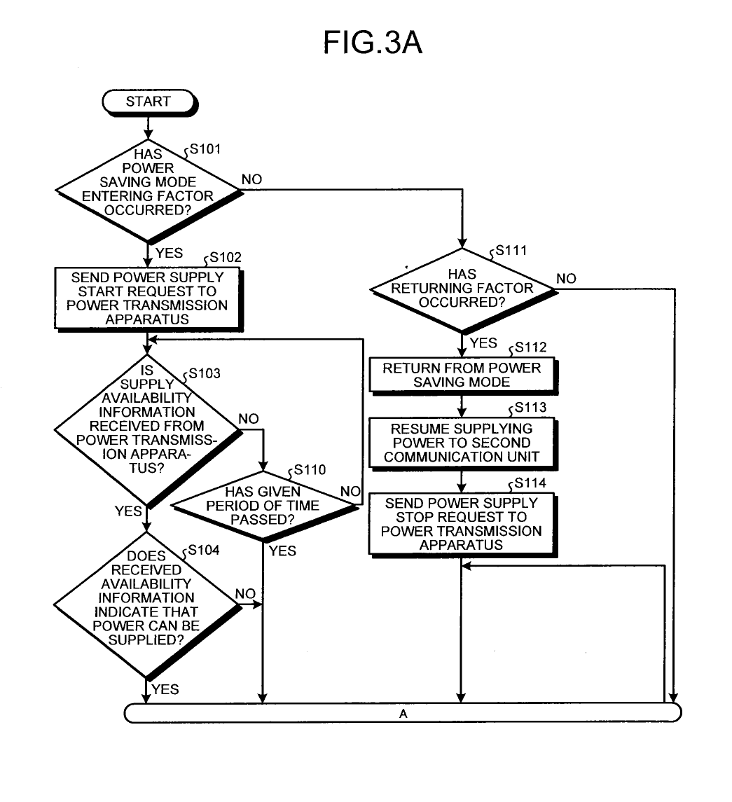

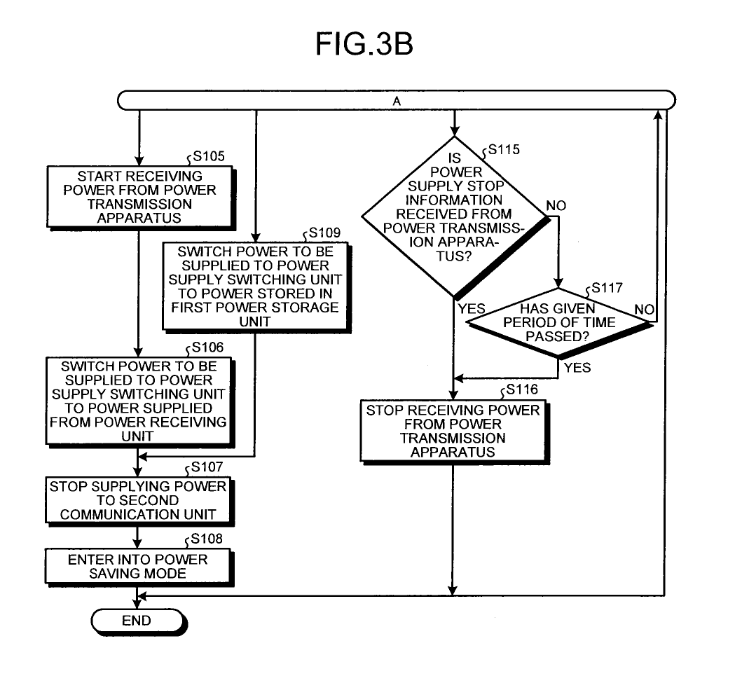

FIGS. 3A and 3B are flow charts illustrating an operation example of the image forming apparatus 20 when entering the power saving mode and when returning from the power saving mode. Specific details of FIGS. 3A and 3B will be described below. As illustrated in FIGS. 3A and 3B, the ASIC 44 first determines whether the power saving mode entering factor has occurred (Step S101). If determining that the power saving mode entering factor has occurred (Yes at Step S101), the ASIC 44 notifies the power supply control unit 65 to enter the power saving mode (power saving mode enter notification). Upon receiving the power saving mode enter notification, the power supply control unit 65 requests the second communication unit 31 to send the power supply start request to the power transmission apparatus 10. In the present embodiment, the power supply control unit 65 requests the second communication unit 31 to send, in addition to the power supply start request, information such as the identification (ID) information of the image forming apparatus 20 and required power information that indicates an amount of power necessary for the image forming apparatus 20 in the power saving mode. Upon receiving the request from the power supply control unit 65, the second communication unit 31 sends the power supply start request to the power transmission apparatus 10 (Step S102). In the present embodiment, in the case of entering the power saving mode, the second communication unit 31 sends, to the power transmission apparatus 10, information such as the identification (ID) information of the image forming apparatus 20 and the required power information, in addition to the power supply start request.

Next, the power supply control unit 65 determines whether the second communication unit 31 has received the supply availability information from the power transmission apparatus 10 (Step S103). In the present embodiment, the power supply control unit 65 determines whether it has been notified of the supply availability information from the second communication unit 31 to determine whether the second communication unit 31 has received the supply availability information from the power transmission apparatus 10.

If determining that the second communication unit 31 has received the supply availability information from the power transmission apparatus 10 (Yes at Step S103), the power supply control unit 65 determines whether the received supply availability information indicates that the power supply is possible (Step S104). If determining that the received supply availability information indicates that the power supply is possible (Yes at Step S104), the power supply control unit 65 performs control to start receiving the power from the power transmission apparatus 10 (Step S105). For example, the power supply control unit 65 can also control the power receiving unit 61 so as to supply the power received from the power transmission apparatus 10 to the power supply control unit 65. Next, the power supply control unit 65 performs control to switch the power to be supplied to the power supply switching unit 64 to the power supplied from the power receiving unit 61 (currently received power) (Step S106). Next, the power supply control unit 65 controls the power supply switching unit 64 so as to stop the power supply to the second communication unit 31 (Step S107). Next, the power supply control unit 65 performs control to enter the power saving mode (Step S108). More specifically, the power supply control unit 65 controls the power supply switching unit 64 so as to switch the source of power supplied to the units of the image forming apparatus 20 to the power received at the power receiving unit 61 (power supplied from the power supply control unit 65), and so as to stop supplying power to the engine 50 and to the elements other than the ASIC 44 in the controller 40.

If, instead, it is determined at Step S104 described above that the received supply availability information indicates that power cannot be supplied (No at Step S104), the process moves to Step S109. Further, if the second communication unit 31 has not received the supply availability information from the power transmission apparatus 10 (No at Step S103), and if a given period of time has passed since the power supply start request was sent (Yes at Step S110), the process also moves to Step S109.

At Step S109, the power supply control unit 65 performs control to switch the power to be supplied to the power supply switching unit 64 to the power stored (charged) in the first power storage unit 62 (Step S109). The process thereafter is the same as the process of Step S107 and later described above.

If the ASIC 44 determines at Step S101 described above that the power saving mode entering factor has not occurred (No at Step S101), the process moves to Step S111. At Step S111, the ASIC 44 determines whether the returning factor has occurred.

If determining that the returning factor has occurred (Yes at Step S111), the ASIC 44 notifies the power supply control unit 65 to return from the power saving mode (power saving mode return notification). Upon receiving the power saving mode return notification from the ASIC 44, the power supply control unit 65 performs control to return from the power saving mode (Step S112). More specifically, the power supply control unit 65 controls the power supply switching unit 64 so as to switch the source of power supplied to the units of the image forming apparatus 20 to the power from the main power supply 63 (power from the commercial power source), and so as to resume supplying the power to the engine 50 and to the elements other than the ASIC 44 in the controller 40. Then, the power supply control unit 65 controls the power supply switching unit 64 so as to resume supplying the power to the second communication unit 31 (Step S113).

Next, the power supply control unit 65 requests the second communication unit 31 to send the power supply stop request to the power transmission apparatus 10. Upon receiving the request from the power supply control unit 65, the second communication unit 31 sends the power supply stop request to the power transmission apparatus 10 (Step S114). In the present embodiment, the second communication unit 31 sends, in addition to the power supply stop request, the identification (ID) information of the image forming apparatus 20 to the power transmission apparatus 10.

Next, the power supply control unit 65 determines whether the second communication unit 31 has received the power supply stop information from the power transmission apparatus 10 (Step S115). In the present embodiment, the power supply control unit 65 determines whether it has been notified of the power supply stop information from the second communication unit 31 to determine whether the second communication unit 31 has received the power supply stop information from the power transmission apparatus 10.

If determining that the second communication unit 31 has received the power supply stop information from the power transmission apparatus 10 (Yes at Step S115), the power supply control unit 65 performs control to stop receiving the power from the power transmission apparatus 10 (Step S116). For example, the power supply control unit 65 can also control the power receiving unit 61 so as to stop supplying the power received from the power transmission apparatus 10 to the power supply control unit 65. If, instead, the second communication unit 31 has not received the power supply stop information from the power transmission apparatus 10 (No at Step S115), and if a given period of time has passed since the power supply stop request was sent (Yes at Step S117), the power supply control unit 65 also performs the control to stop receiving the power from the power transmission apparatus 10 (Step S116).

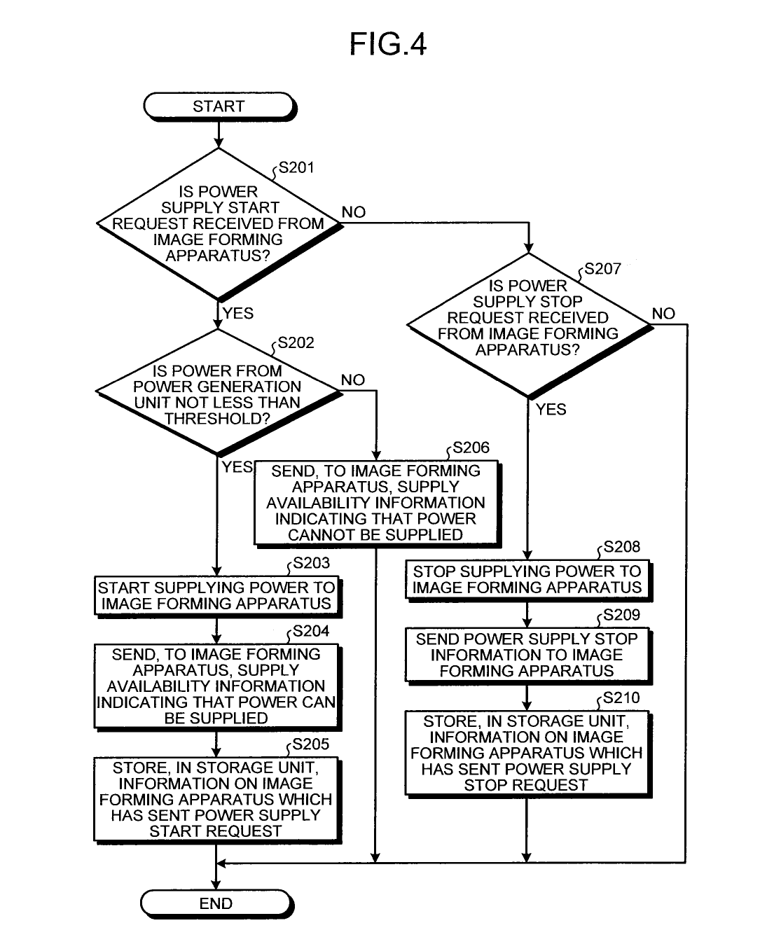

FIG. 4 is a flow chart illustrating an operation example of the power transmission apparatus 10. Specific details of FIG. 4 will be described below. As illustrated in FIG. 4, the power transmission control unit 17 first determines whether the first communication unit 12 has received the power supply start request from the image forming apparatus 20 (Step S201). In the present embodiment, the power transmission control unit 17 determines whether it has been notified of the power supply start request from the first communication unit 12 to determine whether the first communication unit 12 has received the power supply start request from the image forming apparatus 20.

If determining that the first communication unit 12 has received the power supply start request from the image forming apparatus 20 (Yes at Step S201), the power transmission control unit 17 determines whether the power supplied from (power generated by) the power generation unit 11 is not less than a threshold (Step S202).

If determining that the power supplied from the power generation unit 11 is not less than the threshold (Yes at Step S202), the power transmission control unit 17 starts the power supply to the image forming apparatus 20 (Step S203). As described above, in the present embodiment, in the case of entering the power saving mode, the second communication unit 31 sends, to the power transmission apparatus 10, the power supply start request, the identification (ID) information of the image forming apparatus 20, and the required power information. Therefore, at Step S201 described above, the first communication unit 12 receives, in addition to the power supply start request, the identification (ID) information of the image forming apparatus 20 and the required power information. Then, the power transmission control unit 17 performs control to send the power generated in the power generation unit 11 to the image forming apparatus 20 so as to satisfy the amount of power indicated by the required power information received from the image forming apparatus 20. More specifically, the power transmission control unit 17 starts to control the amount of power supplied from the power generation unit 11 to the power transmission unit 16 so as to satisfy the amount of power indicated by the required power information and to send the power supplied from the power generation unit 11 to the power transmission unit 16 to the image forming apparatus 20 using the magnetic field resonance technique.

Next, the power transmission control unit 17 requests the first communication unit 12 to send, to the image forming apparatus 20, the supply availability information indicating that the power supply is possible. Upon receiving the request from the power transmission control unit 17, the first communication unit 12 sends, to the image forming apparatus 20, the supply availability information indicating that the power supply is possible (Step S204). Next, the power transmission control unit 17 stores, in the storage unit 15, the information on the image forming apparatus 20 which has sent the power supply start request (Step S205). More specifically, the power transmission control unit 17 stores, in the storage unit 15, the identification information of the image forming apparatus 20 which has sent the power supply start request, in addition to necessary information (such as supply status information indicating whether the power supply is currently being performed). In this case, the supply status information is set (or updated) to that indicating that the power supply is currently being performed.

If determining at Step S202 described above that the power supplied from the power generation unit 11 is less than the threshold (No at Step S202), the power transmission control unit 17 requests the first communication unit 12 to send, to the image forming apparatus 20, the supply availability information indicating that the power supply is impossible. Upon receiving the request from the power transmission control unit 17, the first communication unit 12 sends, to the image forming apparatus 20, the supply availability information indicating that the power supply is impossible (Step S206), and the process is terminated.

If determining at Step S201 described above that the first communication unit 12 has not received the power supply start request from the image forming apparatus 20 (No at Step S201), the power transmission control unit 17 determines whether the first communication unit 12 has received the power supply stop request (and the identification information) from the image forming apparatus 20 (Step S207). In the present embodiment, the power transmission control unit 17 determines whether it has been notified of the power supply stop request from the first communication unit 12 to determine whether the first communication unit 12 has received the power supply stop request from the image forming apparatus 20.

If determining that the first communication unit 12 has received the power supply stop request from the image forming apparatus 20 (Yes at Step S207), the power transmission control unit 17 stops the power supply to the image forming apparatus 20 (Step S208). More specifically, the power transmission control unit 17 stops supplying the power from the power generation unit 11 to the power transmission unit 16, and stops the control of sending the power to the image forming apparatus 20 using the magnetic field resonance technique. Next, the power transmission control unit 17 requests the first communication unit 12 to send, to the image forming apparatus 20, the power supply stop information that indicates that the power supply is to be stopped. Upon receiving the request from the power transmission control unit 17, the first communication unit 12 sends the power supply stop information to the image forming apparatus 20 (Step S209). Next, the power transmission control unit 17 stores, in the storage unit 15, the information on the image forming apparatus 20 which has sent the power supply stop request (Step S210). More specifically, the power transmission control unit 17 stores, in the storage unit 15, the identification information of the image forming apparatus 20 which has sent the power supply stop request, in addition to the necessary information (such as the supply status information indicating whether the power supply is currently being performed). In this case, the supply status information is set (or updated) to that indicating that the power supply is currently stopped.

As has been described above, in the present embodiment, the system configuration is such that the power transmission apparatus 10 provided with the power generation unit 11 composed of the photovoltaic cell is provided separately from the image forming apparatus 20, and the power generated in the power generation unit 11 is supplied to the image forming apparatus 20 using the magnetic field resonance technique. Accordingly, it is possible to sufficiently ensure the power generated in the power generation unit 11 by installing the power transmission apparatus 10 at a place sufficiently irradiated with sunlight.

Here, in the system configuration in which a power transmission apparatus having a power generation unit such as a photovoltaic cell is provided separately from an image forming apparatus, and the power generated in the power generation unit is supplied to the image forming apparatus using the magnetic field resonance technique, the image forming apparatus needs to be provided, separately from an external I/F that can receive image data or the like from a host device such as a PC, with a communication unit (corresponding to the “second communication unit 31” of the present embodiment) for requesting the power transmission apparatus to start or stop supplying the power. From the viewpoint of energy saving, it is desirable to suppress the power consumption of the above-mentioned communication unit as much as possible.

As described above, in the present embodiment, in the case of entering the power saving mode, the power supply control unit 65 performs control to stop supplying power to the second communication unit 31. Therefore, it is possible to reduce the power consumption of the communication apparatus 30 which communicates with the power transmission apparatus 10. Alternatively, instead of stopping supplying power to the second communication unit 31, the power supply control unit 65 may be configured, in the case of entering the power saving mode, to control the power supplied to the second communication unit 31 to a value smaller than the power supplied to the second communication unit 31 in the normal mode. This configuration can also reduce the power consumption of the communication apparatus 30. The essential point is that, the power supply control unit 65 only needs to control, in the case of entering the power saving mode, the power supplied to the second communication unit 31 to a value (including 0 V) smaller than the power supplied to the second communication unit 31 in the normal mode.

In the present embodiment, in the case of entering the power saving mode, the power supply control unit 65 also performs, in addition to the control to stop supplying power to the second communication unit 31, the control to switch the source of power supplied to the units of the image forming apparatus 20 to the power received at the power receiving unit 61. Therefore, it is possible to use as little power as possible from the commercial power source while reducing the power consumption of the communication apparatus 30. According to the present embodiment described above, it is possible to provide an image forming system that can achieve further reduction in power consumption.

### Second Embodiment

Next, a second embodiment of the present invention will be described. The second embodiment differs from the first embodiment in that the power transmission apparatus is provided with a power storage unit that stores therein the power generated in the power generation unit. Specific description will be made below. Note that the same numerals are used for the parts in common with those in the above-described first embodiment, and description thereof will be omitted as appropriate.

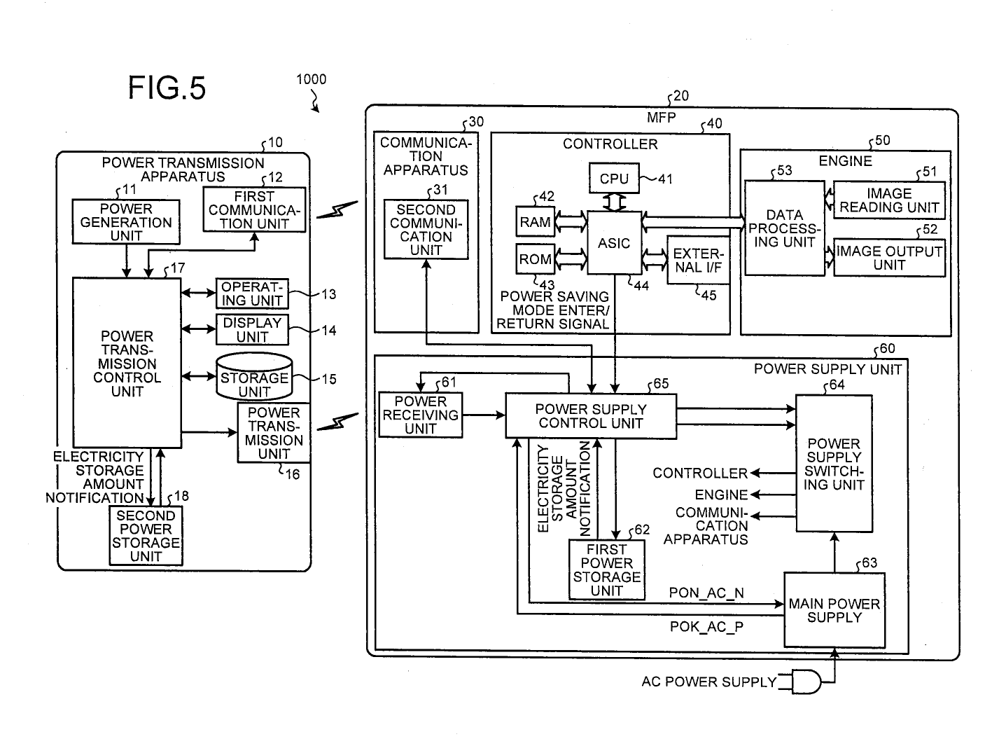

FIG. 5 is a block diagram illustrating a hardware configuration example of an image forming system (power control system) 1000 of the second embodiment. As illustrated in FIG. 5, the image forming system 1000 is provided with a power transmission apparatus 1 and the image forming apparatus 20. The power transmission apparatus 1 differs from the power transmission apparatus 10 of the first embodiment in being further provided with a second power storage unit 18. The other configuration is the same as that of the first embodiment.

Under the control of the power transmission control unit 17, the second power storage unit 18 stores (accumulates) therein the power generated in the power generation unit 11. The second power storage unit 18 can also discharge the stored power under the control of the power transmission control unit 17. Further, the second power storage unit 18 can notify the power supply control unit 65 of an electricity storage amount of itself. The first power storage unit 62 can be composed, for example, of a secondary battery such as a lithium secondary battery or a nickel-metal hydride battery, or of a capacitor. However, the component is not limited to the above-listed ones.

The power transmission control unit 17 performs charge/discharge control of the second power storage unit 18 based on the electricity storage amount notification from the second power storage unit 18. The power transmission control unit 17 can perform control to charge the second power storage unit 18 with the power from the power generation unit 11, or can alternatively perform control to supply (discharge) the power stored in the second power storage unit 18 to the power transmission unit 16 and to send the power to the image forming apparatus 20 using the magnetic field resonance technique.

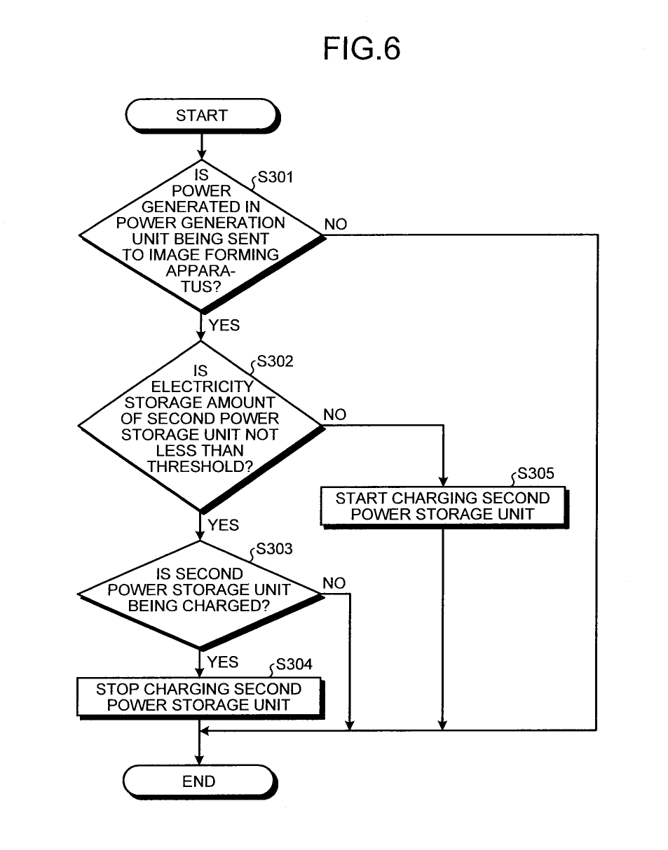

FIG. 6 is a flow chart illustrating an example of the charge control of the second power storage unit 18. As illustrated in FIG. 6, the power transmission control unit 17 first determines whether the power generated by the power generation unit 11 is being sent to the image forming apparatus 20 (Step S301). In other words, the power transmission control unit 17 determines whether the power is currently being supplied to the image forming apparatus 20.

If determining that the power is currently being supplied (Yes at Step S301), the power transmission control unit 17 determines, based on the electricity storage amount notification from the second power storage unit 18, whether the electricity storage amount of the second power storage unit 18 is not less than a threshold (Step S302).

If determining that the electricity storage amount of the second power storage unit 18 is not less than the threshold (Yes at Step S302), the power transmission control unit 17 determines whether the power generated in the power generation unit 11 is currently being charged to the second power storage unit 18 (Step S303). If, instead, determining that the electricity storage amount of the second power storage unit 18 is less than the threshold (No at Step S302), the power transmission control unit 17 starts performing control to charge the second power storage unit 18 with the power generated in the power generation unit 11 (Step S305).

If determining at Step S303 described above that the power generated in the power generation unit 11 is currently being charged to the second power storage unit 18 (Yes at Step S303), the power transmission control unit 17 performs control to stop charging the second power storage unit 18 (Step S304). If, instead, it is determined at Step S303 described above that the power generated in the power generation unit 11 is not currently being charged to the second power storage unit 18 (No at Step S303), the process is terminated.

As has been described above, in the present embodiment, the power transmission apparatus 1 is provided with the second power storage unit 18 that stores therein the power generated in the power generation unit 11, and accordingly has an advantage that the power stored in the second power storage unit 18 can be supplied to the image forming apparatus 20 even in the case of a bad weather such as a cloudy or a rainy weather, or in the case of a nighttime when the output of the photovoltaic cell drops.

### Modifications

While the embodiments of the present invention have been described above, the present invention is not limited to the above-described embodiments, but various modifications can be made within the scope that does not depart from the gist of the present invention.

(1) First Modification

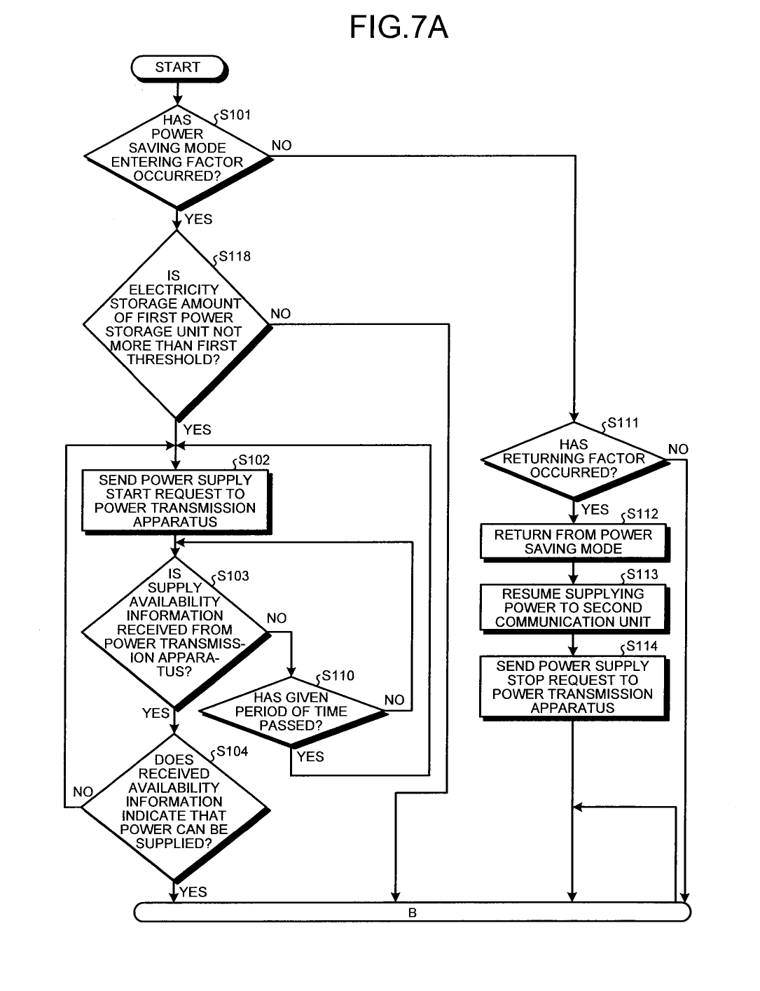

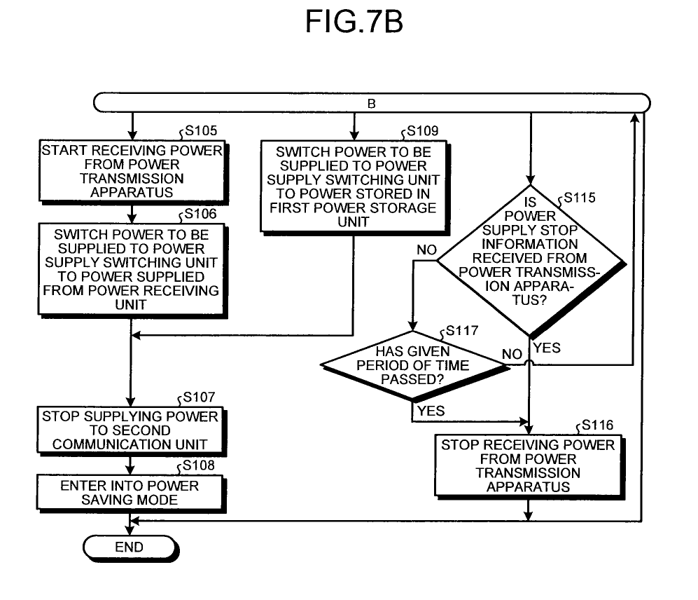

For example, in the case of entering the power saving mode, the power supply control unit 65 can perform control to switch the source of power supplied to the units of the image forming apparatus 20 to the power stored in the first power storage unit 62 if the power stored in the first power storage unit 62 is not less than the first threshold. FIGS. 7A and 7B are flow charts illustrating an operation example of the image forming apparatus 20 in this case. The example of FIGS. 7A and 7B differs from the example of FIGS. 3A and 3B in that Step S118 is newly added. Description will be made below focusing on differences from the example of FIGS. 3A and 3B.

As described in FIGS. 7A and 7B, after Step S101, the power supply control unit 65 determines, based on the electricity storage amount notification from the first power storage unit 62, whether the electricity storage amount of the first power storage unit 62 is not more than the first threshold (Step S118). If the electricity storage amount of the first power storage unit 62 is determined to be not more than the first threshold (Yes at Step S118), the process moves to Step S102. Although the process of Step S102 and later is basically the same as that of FIG. 3A, the process differs from that of the first embodiment in that the process returns to Step S102 if the supply availability information indicating that the power supply is impossible is received from the power transmission apparatus 10 (No at Step S104), or if the given period of time has passed since the power supply start request was sent to the power transmission apparatus 10 (Yes at Step S110). Specifically, in this example, in the case of entering the power saving mode, if the power transmission apparatus 10 cannot supply power and if the power stored in the first power storage unit 62 is less than the first threshold, the power supply control unit 65 performs control of waiting until the power transmission apparatus 10 becomes capable of supplying power.

If, instead, the electricity storage amount of the first power storage unit 62 is determined to be not less than the first threshold (No at Step S118), the power supply control unit 65 performs the control to switch the power to be supplied to the power supply switching unit 64 to the power stored in the first power storage unit 62 (Step S109). Next, the power supply control unit 65 controls the power supply switching unit 64 so as to stop the power supply to the second communication unit 31 (Step S107). Next, the power supply control unit 65 performs the control to enter the power saving mode (Step S108). More specifically, the power supply control unit 65 controls the power supply switching unit 64 so as to switch the source of power supplied to the units of the image forming apparatus 20 to the power supplied from the power supply control unit 65 (power stored in the first power storage unit 62), and so as to stop supplying power to the engine 50 and to the elements other than the ASIC 44 in the controller 40. As described above, in the case of entering the power saving mode, the power supply control unit 65 performs the control to switch the source of power supplied to the units of the image forming apparatus 20 to the power stored in the first power storage unit 62 if the power stored in the first power storage unit 62 is not less than the first threshold.

(2) Second Modification

In each of the above-described embodiments, the image forming system includes only one image forming apparatus 20. However, not limited to this configuration, the image forming system can include any number of image forming apparatuses. For example, the system configuration may be such that one power transmission apparatus supplies power to each of a plurality of image forming apparatuses. In this configuration, in the case of supplying the power to each of the image forming apparatuses, the power transmission control unit 17 can control the amount of power supplied from the power generation unit 11 to the power transmission unit 16 so as to satisfy the sum of the amounts of power each indicated by the required power information from each of the image forming apparatuses, and can perform control to send the power to the image forming apparatuses using the magnetic field resonance technique.

(3) Third Modification

For example, if the power stored in the first power storage unit 62 is less than the second threshold after the image forming apparatus 20 enters the power saving mode in the state in which the source of power supplied to the units of the image forming apparatus 20 is switched to the power stored in the first power storage unit 62, the power supply control unit 65 can perform control to request the power transmission apparatus 10 to start supplying power. The power supply control unit 65 can, for example, request the second communication unit 31 to send the power supply start request to the power transmission apparatus 10. With this configuration, the power supply to the elements (such as the ASIC 44) of the image forming apparatus 20 that are to be operated even during the power saving mode is prevented from being stopped by depletion of the power stored in the first power storage unit 62.

(4) Fourth Modification

For example, in the power saving mode, if the power generated in the power generation unit 11 or the power stored in the second power storage unit 18 (or the sum of these powers) is reduced below a threshold, and thus, if the amount of power required by the image forming apparatus 20 (amount of power indicated by the required power information) cannot be supplied, the power supply control unit 65 can notify the image forming apparatus 20 of the impossibility of supply. If receiving this notification, the power supply control unit 65 can perform the control to switch the source of power supplied to the units of the image forming apparatus 20 to the power from the main power supply 63 (power from the commercial power source), or can alternatively perform the control to return from the power saving mode to the normal mode.

The embodiments and the modifications described above can be arbitrarily combined with each other.

The control programs executed in the image forming apparatus (power supply control unit 65) of each of the above-described embodiments may be configured to be provided by being recorded in a computer-readable recording medium such as a CD-ROM, a flexible disk (FD), a CD-R, or a digital versatile disc (DVD) as files in an installable or an executable format.

Alternatively, the control programs executed in the image forming apparatus of each of the above-described embodiments may be configured to be provided by being stored on a computer connected to a network such as the Internet and downloaded via the network. Still alternatively, the control programs executed in the image forming apparatus of each of the above-described embodiments may be configured to be provided or distributed via a network such as the Internet. Assume that an electronic apparatus (such as the image forming apparatus of each of the above-described embodiments) is provided with processing units (such as the controller 40 and the engine 50) that perform processing, a communication unit (such as the second communication unit 31) that sends, to a power transmission apparatus that can send power generated thereby to an external device, a request for starting or stopping supplying the power, and a power receiving unit that receives the power from the power transmission apparatus. Then, the programs of the present invention can also be understood as programs for making the electronic apparatus execute control steps to control, in the case of entering the power saving mode in which power consumption is smaller than that in the normal mode in which the power is supplied to each of the processing units and the communication unit, the power supplied to the communication unit to a value smaller than the power supplied to the communication unit in the normal mode.

According to the embodiments, it is possible to provide an advantageous effect of bringing about further reduction in power consumption.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A power control system comprising:
an electronic apparatus; and
a power transmission apparatus configured to send power to the electronic apparatus, wherein
the power transmission apparatus includes
a power generation unit configured to generate the power;
a first communication unit configured to communicate with the electronic apparatus; and
a power transmission unit configured to send the power generated by the power generation unit to the electronic apparatus in response to a request from the electronic apparatus received at the first communication unit, and
the electronic apparatus includes
a processing unit configured to perform a process;
a second communication unit configured to send, to the power transmission apparatus, a request for starting or stopping supplying the power;
a power receiving unit configured to receive the power from the power transmission apparatus; and
a power supply control unit configured to control, in a power saving mode in which power consumption is smaller than that in a normal mode in which the power is supplied to the processing unit and the second communication unit, the power supplied to the second communication unit to a value smaller than the power supplied to the second communication unit in the normal mode.

2. The power control system according to claim 1, further comprising a power supply switching unit configured to switch a source of power supplied to the processing unit and the communication unit to either power from a commercial power source or the power received at the power receiving unit, wherein
the power supply control unit performs control to switch the source of power to the power received at the power receiving unit to enter the power saving mode.

3. The power control system according to claim 2, further comprising a first power storage unit configured to store therein the power received at the power receiving unit, wherein
if the power transmission apparatus is incapable of supplying power when the electronic apparatus enters the power saving mode, the power supply control unit performs control to switch the source of power to the power stored in the first power storage unit.

4. The power control system according to claim 3, wherein
when the power stored in the first power storage unit is less than a second threshold in the power saving mode, the second communication unit sends, to the power transmission apparatus, a power supply start request that requests the power transmission apparatus to start supplying power.

5. The power control system according to claim 2, further comprising a first power storage unit that stores therein the power received at the power receiving unit, wherein
if the power stored in the first power storage unit is not less than a first threshold when the electronic apparatus enters the power saving mode, the power supply control unit performs control to switch the source of power to the power stored in the first power storage unit.

6. The power control system according to claim 5, wherein
when the power stored in the first power storage unit is less than a second threshold in the power saving mode, the second communication unit sends, to the power transmission apparatus, a power supply start request that requests the power transmission apparatus to start supplying power.

7. The power control system according to claim 1, wherein
the power transmission apparatus further includes a power transmission control unit configured to perform control to send the power generated by the power generation unit to the electronic apparatus,
the second communication unit sends to the power transmission apparatus, to enter the power saving mode, a power supply start request that requests the power transmission apparatus to start supplying power and required power information that indicates an amount of power necessary for the electronic apparatus in the power saving mode, and
when the first communication unit receives the power supply start request and the required power information, the power transmission control unit performs control to send the power generated by the power generation unit to the electronic apparatus so as to satisfy the amount of power indicated by the required power information.

8. The power control system according to claim 1, wherein the power transmission apparatus further includes a second power storage unit configured to store therein the power generated by the power generation unit.

9. The power control system according to claim 1, wherein the power transmission unit uses a magnetic field resonance technique to send the power generated by the power generation unit to the electronic apparatus.

10. The power control system according to claim 1, wherein the power generation unit includes a photovoltaic cell.

11. An electronic apparatus comprising:
a processing unit configured to perform a process;
a communication unit configured to send, to a power transmission apparatus configured to send generated power to an external device, a request for starting or stopping supplying the power;
a power receiving unit configured to receive the power from the power transmission apparatus; and
a power supply control unit configured to control, in a power saving mode in which power consumption is smaller than that in a normal mode in which the power is supplied to the processing unit and the communication unit, the power supplied to the communication unit to a value smaller than the power supplied to the communication unit in the normal mode.
